(19) United States
(12) Patent Application Publication
(10) Pub. No.: US 2010/0283885 A1
(43) Pub. Date: Nov. 11, 2010

(54) METHOD FOR ALIGNING PIXILATED MICRO-GRID POLARIZER TO AN IMAGE SENSOR

(76) Inventors: Shih-Schon Lin, Philadelphia, PA (US); Selim S. Bencuya, Irvine, CA (US); Charles Anthony White, Oakland, CA (US); David Hendricks, Palo Alto, CA (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(21) Appl. No.: 12/777,938

(22) Filed: May 11, 2010

Related U.S. Application Data
(60) Provisional application No. 61/177,126, filed on May 11, 2009.

(51) Int. Cl. H04N 5/225

(52) U.S. Cl. 348/340; 348/E05.091

(57) ABSTRACT

Aligning a cut-to-size (off-wafer) pixilated micro-grid polarizer to a ready packaged imaging sensor having multiple pixels involves minimizing a separation distance between the two units and then aligning respective corresponding pixels of the pixilated micro-grid polarizer with the pixels of the imaging sensor using optical signals as position feedback during the alignment process. Once the alignment has been achieved, the micro-grid polarizer may be affixed to the imaging sensor, for example using optical epoxy glue.

### RELATED APPLICATION

This application is a NONPROVISIONAL of and hereby claims priority to U.S. Provisional Patent Application No. 61/177,126, filed May 11, 2009, incorporated herein by reference.

### FIELD OF THE INVENTION

The present invention relates to methods for aligning a pixilated micro-grid polarizer to a ready-to-run image sensor having multiple pixels.

### BACKGROUND

Polarization is a property of electromagnetic waves, such as light, that describes the orientation of the oscillation of the waves. By convention, it is the orientation of the electric field component of an electromagnetic wave over one period of its oscillation that defines the wave's polarization. The state of polarization of an electromagnetic wave can be determined using polarimetry.

To measure such polarization states, it is common to use polarizers as filters for image sensors (e.g., charged coupled devices (CCDs) or other sensors). The polarizers often are arranged in checkerboard fashion, with each pixel of the polarizer configured to pass light of a different polarization state and aligned to a corresponding pixel of the image sensor. This permits measurement of the intensity of direct or reflected light in each of the corresponding polarizer pixel orientations detected by pixels across the image sensor and, ultimately, a determination of the polarization state of that light.

In order to make accurate measurements of polarization state, it is critical that the polarizer be aligned accurately to the image sensor. While gross alignments therebetween can be made with expensive microscopy equipment and using fiducial marks or other complementary alignment aids embossed on the sensor and the polarizer wafers before they are cut or diced, these marks are not available after sensors and polarizers are cut from wafers and packaged.

### SUMMARY OF THE INVENTION

In one embodiment, the present invention provides a method of aligning a pixilated micro-grid polarizer to an imaging sensor having multiple pixels (e.g., one that is packaged and “ready to run” and which has a pixel pitch approximately equal to that of the polarizer). Initially, a coarse optical alignment of respective corresponding pixels of the pixilated micro-grid polarizer with pixels of the imaging sensor is performed. Thereafter, a separation distance between the pixilated micro-grid polarizer and the imaging sensor is minimized. The respective corresponding pixels of the pixilated micro-grid polarizer are then aligned with the pixels of the imaging sensor, rotationally, in attitude, and translationally, in an iterative manner. Once the alignment has been achieved, the micro-grid polarizer may be affixed to the imaging sensor, for example using an epoxy (e.g., optical epoxy glue).

The coarse optical alignment may be performed visually, to position the respective corresponding pixels of the pixilated micro-grid polarizer over the pixels of the imaging sensor. To aid in this coarse alignment process, a regulated stable light source uniformly collimated to impinge the sensor along an axis normal to its surface is turned on and stabilized. A linear polarizer (with an adjustable polarization axis direction) is introduced between the light source and the alignment assembly (the pixilated micro-grid polarizer and the imaging sensor) and the polarization axis approximately aligned with one of the polarization axes of the pixilated polarizer when it is well aligned with the sensor. An intensity video signal output from the imaging sensor may be displayed on a color monitor (e.g., a display of a computer system configured to provide an intensity reading output) and the position of the micro-grid polarizer adjusted relative to the imaging sensor until a particular visual pattern vanishes or is minimized and certain contrasts are maximized. Alternatively, in a fully or partially automated system, the output from the imaging sensor may be provided to a controller and used by the controller to adjust the relative position of the micro-grid polarizer and imaging sensor (e.g., by issuing appropriate commands to a positioning system) according to an overall intensity output from the imaging sensor.

To minimize the separation distance between the imaging sensor and the micro-grid polarizer the imaging sensor may be illuminated (through the micro-grid polarizer) using light that is polarized parallel to one of a plurality of angles of pixels of the micro-grid polarizer. The imaging sensor is operating during these procedures in order to provide visual feedback (either via human observer or automated unit). The separation distance may then be adjusted with the aid of the visual feedback.

Aligning the respective corresponding pixels of the pixilated micro-grid polarizer with the pixels of the imaging sensor along axes of rotation and attitude may involve illuminating the imaging sensor with polarized light aligned with one of a plurality of polarization angles of pixels of the micro-grid polarizer, rotating the imaging sensor and micro-grid polarizer relative to one another about a common axis while monitoring a pseudo color output of the imaging sensor until a uniform hue is observed. This uniform hue pattern may be monitored on all polarization angles of pixels of the micro-grid polarizer to ensure rotational alignment is achieved for all such polarization angles. If a uniform hue is not achievable it is an indication of a problem with the polarizer.

Translationally aligning the respective corresponding pixels of the pixilated micro-grid polarizer with the pixels of the imaging sensor may involve illuminating the imaging sensor with polarized light aligned with one of a plurality of polarization angles of pixels of the micro-grid polarizer; monitoring extinction ratios of an output of the imaging sensor; and translating the imaging sensor and the micro-grid polarizer relative to one another in a horizontal plane, while maintaining a constant separation distance and rotational aspect therebetween, until the extinction values reach their respective maximum values. If needed, the rotational, attitude and translational alignment can be iterated until desired results are obtained.

These and further embodiments and aspects of the present invention are described in greater detail below.

### BRIEF DESCRIPTION OF THE DRAWINGS

The present invention is illustrated by way of example, and not limitation, in the figures of the accompanying drawings in which:

FIG. 1 illustrates an example of a pixilated micro-grid polarizer which may be aligned with an imaging sensor in accordance with the present invention;

FIG. 2 illustrates a cross-section of a portion of the pixilated micro-grid polarizer shown in FIG. 1;

FIG. 3 illustrates an example of a pixilated micro-grid polarized aligned pixel-for-pixel with an imaging sensor, in accordance with an embodiment of the present invention;

FIG. 4 illustrates an example of a system for aligning a pixilated micro-grid polarizer to an image sensor having multiple pixels, in accordance with an embodiment of the present invention;

FIG. 5 illustrates a process for aligning a pixilated micro-grid polarizer to an image sensor having multiple pixels, in accordance with an embodiment of the present invention; and

FIG. 6 illustrates an example of a pseudo-color encoding pattern.

### DETAILED DESCRIPTION

Described herein are methods for aligning a pixilated micro-grid polarizer to an image sensor having multiple pixels. In various embodiments of the invention, the micro-grid polarizer may be fashioned in checkerboard-style (meaning that the orientation of an individual pixel is different than that of its immediate neighbor pixels), with each pixel of the polarizer configured to pass light of a certain polarization state and arranged into “super pixel” groups of adjacent pixels. For example, one such polarizer may include super-pixels of 2×2 four adjacent pixels, configured to pass light of a polarization oriented in top-left 0°, top-right 45°, lower-left 135°, lower-right 90°, with the definition of 0° direction arbitrarily chosen to be along the row direction of the sensor. The pixels of the polarizer correspond to pixels of ideally the same pixel dimensions and pixel pitch, at least close enough such that within the longest separation distance across the chip the cumulative error would be undetectable for the sensor. The present methods are directed to aligning these corresponding pixels of the polarizer and the image sensor in a highly accurate manner so that the overall output of the image sensor is maximized.

As indicated above, fiducial marks or other complementary alignment aids are typically not available after sensors and polarizers are cut from their respective wafers and packaged. Small companies and individuals cannot afford to custom design and fabricate sensor and polarizer wafers in small quantities, but can readily obtain packaged sensors and matching cut pixilated polarizers for much less cost. The present invention enables accurate alignment of such packaged sensors and matching pixilated polarizer pieces without requiring custom embossed alignment marks on such pieces.

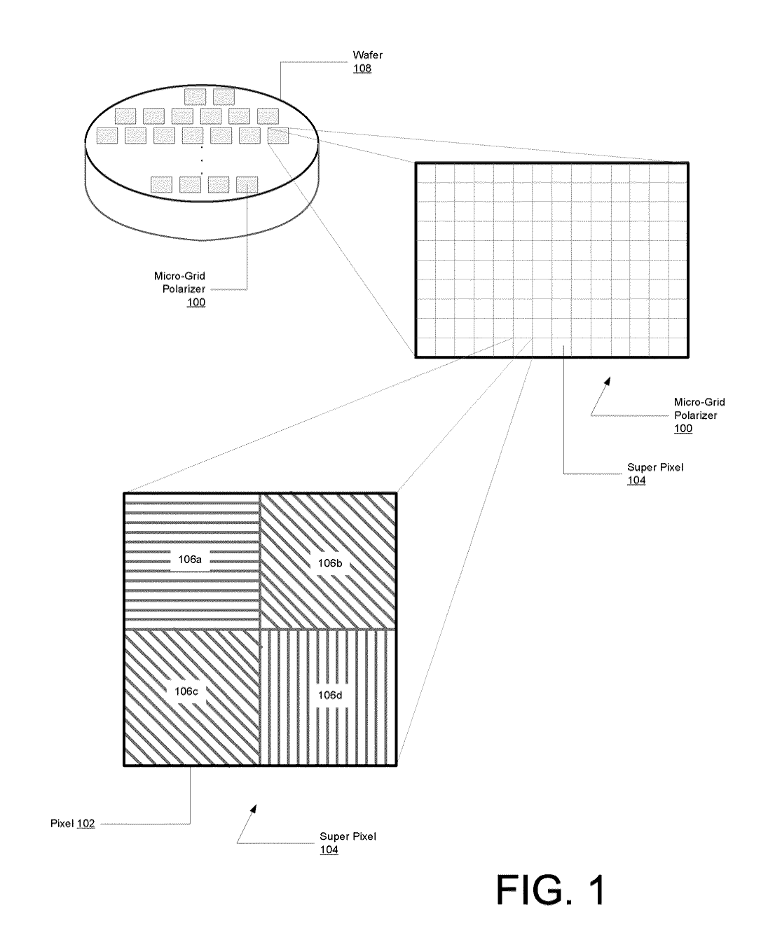

To better appreciate the context within which the present alignment methods find particular application, consider the micro-grid polarizer 100 shown in FIG. 1. Micro-grid polarizer 100 is made up of a plurality of individual pixels 102. Each group of four adjacent pixels 102, each of which is configured to pass light of a particular polarization state, forms a super pixel 104. More specifically, each super pixel 104 is composed of pixels 106a-106d, where pixel 106a is configured to pass light that is vertically polarized, pixel 106b is configured to pass light that is polarized at 45°, pixel 106c is configured to pass light that is polarized at 135°, and pixel 106d is configured to pass light that is horizontally polarized (here the 0° direction is chosen to be the horizontal direction and angles increase in counter-clockwise fashion). Of course, polarizers having pixels with other polarization orientations may be used and super pixels may consist of two, four, or more pixels.

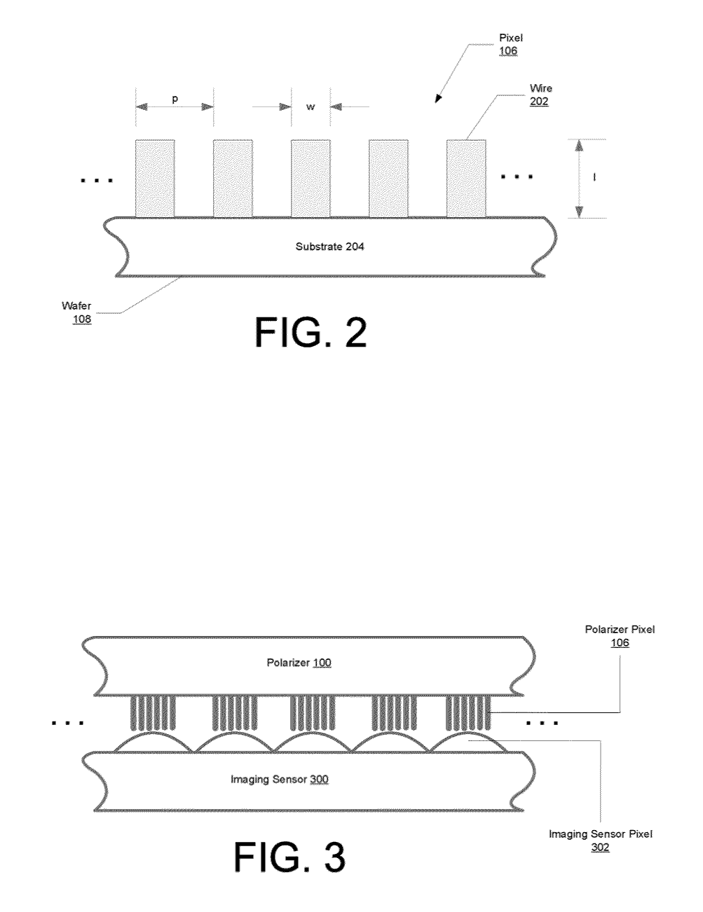

A number of individual polarizers 100 may be fabricated on a common wafer 108, similar to the manner in which integrated circuit dies are made. As shown in FIG. 2, which is a cross-section of a polarizer 100, the pixels of each polarizer can be fashioned from individual conductor wires 202, which are fabricated on the wafer substrate 204. The wires may be fashioned by forming a metal layer over the substrate and then patterning and etching the metal layer using conventional photolithographic techniques common in the semiconductor fabrication arts. The wires may be made of aluminum, or any highly conductive material, and the substrate may be quartz glass, fused silica or other material that is transparent to the wavelengths of electromagnetic radiation of interest. The wires may be fashioned from a single metal layer or from multiple layers (produced using multiple deposition-pattern-etch cycles). The pitch, “p”, and thickness, “w”, of the wires depends upon the wavelength of electromagnetic radiation of interest in that the pitch between wires must be small compared to the wavelength to be polarized, and in one embodiment are optimized for light in the visible spectrum. In one particular embodiment of the invention it is intended to polarize visible light centered around 550 nm wavelength, p is approximately 150 nm, w is approximately 70 nm, and the thickness, “l”, of the wires is approximately 140 nm.

After the polarizer dies have been fabricated, they are cut from wafer 108 (much like semiconductor integrated circuits are diced) and aligned, pixel-by-pixel, with the pixels of an imaging sensor 300, as shown in FIG. 3. The imaging sensor may be a CCD or other imaging sensor. During the alignment process, individual pixels 106 of the polarizer 100 are aligned with individual pixels 302 of the imaging sensor 300. When the alignment is complete, the imaging sensor and polarizer may be affixed together using an epoxy (e.g., optical epoxy glue) or other fastening device or material. For example, the polarizer and imaging sensor may be affixed using an epoxy (e.g., an optical epoxy glue) applied only to mating or abutting edges of the two assemblies.

In other instances, rather than wire grids, the polarizer may consist of a polarizing film deposited or otherwise fabricated on top of a substrate. Such films may be fabricated to provide super pixels of two or more pixels, each with a different polarization angle. The alignment methods discussed herein are equally applicable to polarizers fashioned using thin films and/or wire grids, provided that thickness of the thin films are thin enough to avoid excessive cross-talk between pixels, for example a particular embodiment has 7.4 μm pixel pitch and the polarizer layer height is 70 nm. As should be apparent, the pixels of the polarizer are fabricated so as to be approximately the same size (e.g., length and width, or diameter) as those of the imaging sensor.

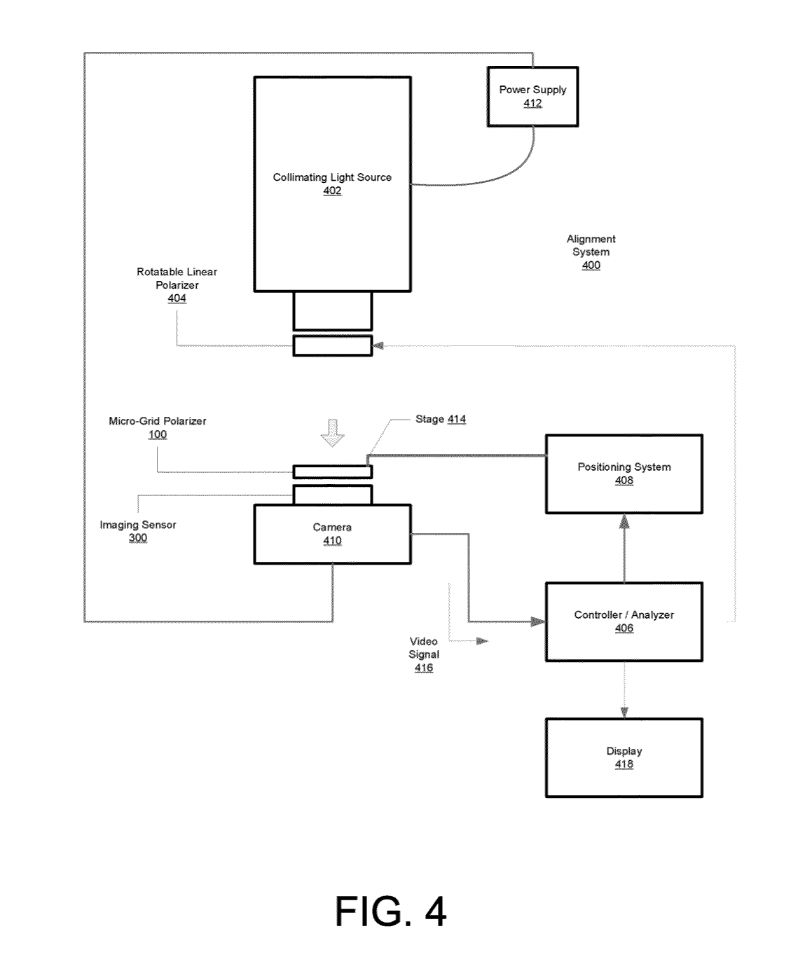

Referring now to FIG. 4, a system 400 for aligning a pixilated micro-grid polarizer and an imaging sensor having individual pixels is shown. The alignment system includes a collimated light source 402 that is configured to illuminate the imaging sensor 300 uniformly. The light source is also equipped with a linear polarizer 404 that is capable of providing polarization at different angles as needed (e.g., under the control of a controller 406). The alignment system also includes a positioning system 408, which is configured to operate under the control of controller 406 to adjust the position of the micro-grid polarizer 100 relative to the imaging sensor 300.

During alignment operations, light from light source 402 passes through the linear polarizer 404 and the micro-grid polarizer 100 to imaging sensor 300. As shown, imaging sensor 300 may be part of a camera 410. The camera (i.e., the imaging sensor) is powered on during the alignment procedure (e.g., using a power supply 412, which may or may not be the same power supply used for the light source); hence, the alignment process is referred to as an active alignment. The output of the camera is provided to the controller/analyzer 406, which is configured to monitor the output of the camera and provide control signals to positioning system 408 as needed, in order to align the respective pixels of the micro-grid polarizer and the imaging sensor. Alternatively, the controller may provide an output to an operator which instructs the operator as to how to change the relative position of the micro-grid polarizer and imaging system using the positioning system.

In order to facilitate the precision alignment needed, either the camera 410 or the micro-grid polarizer 100 or both is/are placed on (a) stage(s) or other frame 414 that is under the control of the positioning system 408. The positioning system and stage(s) have a total of no less than six degrees of freedom, hence, the polarizer and imaging sensor may be translated in two dimensions within a plane relative to one another, displaced vertically from one another (i.e., increasing or decreasing a separation distance therebetween), rotated with respect to one another about a central axis, and tilted relative to one another about the two orthogonal axes defining the plane of translational movement. In one embodiment of the invention, the minimum movement step of the micro-grid polarizer and imaging sensor relative to one another are smaller than five percent (5%) of the pixel dimension (i.e., pixel pitch), at least along the translational and vertical displacement axes.

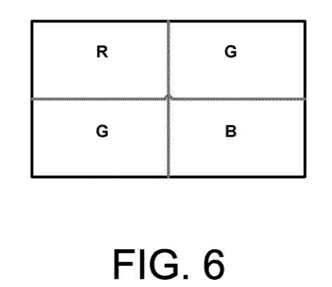

As mentioned, the controller 406 is configured to determine how the micro-grid polarizer and imaging sensor need to be positioned with respect to one another in order to achieve optimum alignment. To facilitate this operation, a video signal 416 is provided from the camera to the controller, to provide feedback information. In case the system has man-in-the-loop the image display can be switched between pseudo-color mode and regular monochrome mode. The pseudo-color display is used to take advantage of the human color vision sensitivity against non-color or grey background. With special encoding to translate incoming video signal into pseudo-color display the overview image color pattern would show special colorful patterns that grows and shrink with respect to how well rotational and tilting alignment is between the sensor pixels and the polarizer grids. When good alignment is achieved the multi-color patterns disappears and smooth close to uniform hue is displayed across the image. Examples of possible pseudo-color encoding patterns are shown in FIG. 6.

In this illustration, the grids represent the 2×2 pixel group at the top left corner of the sensor pixels. The letter R in the pixel position means that the intensity output of that pixel is considered to be an input for a Red channel in a Red-Green-Blue (RGB) monitor output. G represents a Green channel and B represents a Blue channel. Such a pattern would be repeated across the entire sensor area. Many different interpolation algorithms can be used to fill the missing pixel values for each channel, then for each pixel the R, G, B values are provided directly to corresponding RGB channels of an RGB color monitor. Other permutations can also be used, as long as the color channels of adjacent pixels (directly to top and bottom and to left and right) has different channel encoding and the same pattern is repeated through out the entire sensor area.

The controller also computes extinction ratios R1 and R2 for each pixel in part of or the entire frame, where:

R1=Max Intensity(pixel group 1, 4)/Min Intensity(pixel group 1, 4); and

R2=Max Intensity(pixel group 2, 3)/Min Intensity(pixel group 2, 3).

When a visual representation of the camera signal is displayed to an operator, additional magnified views at least at the four corners and for the center of the image are displayed and local statistics of pixel values in each of the four pixel groups and the ratios R1 and R2 are computed and displayed. It is important, though, to monitor at least extreme corners because of the limited sampling of the sensor array of the polarizer grid. Small fractions of misalignment may not be detectable when only one corner is monitored and such fractional error would accumulate and become detectable only at far away corners.

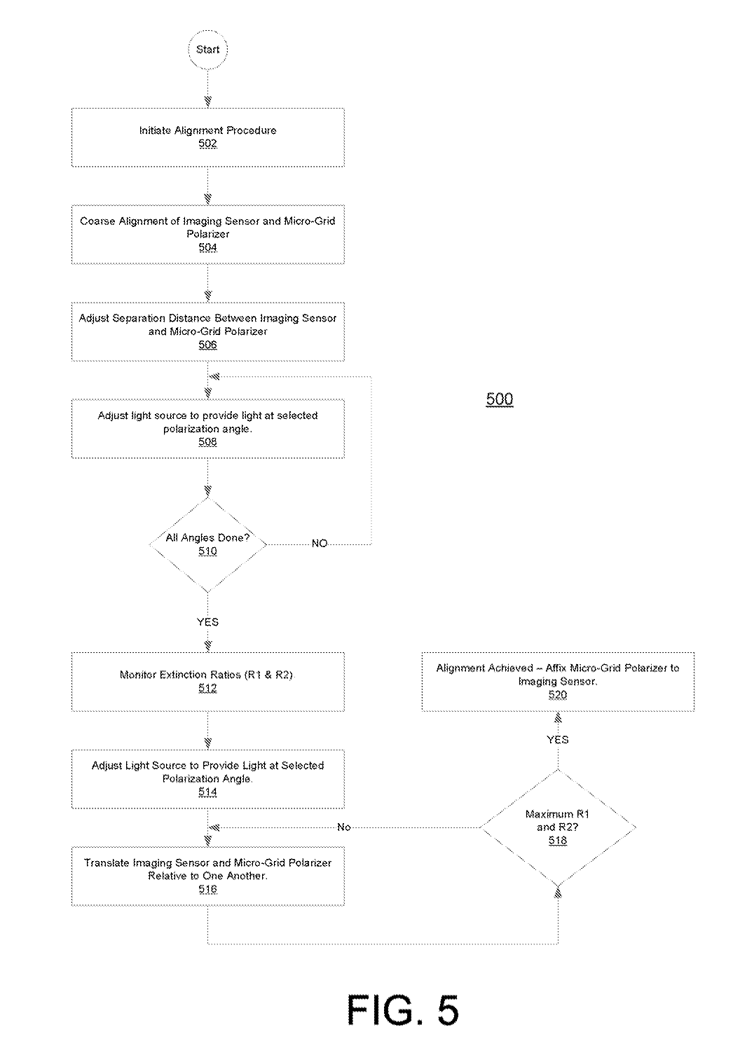

Referring now to FIG. 5, a more detailed description of a process 500 for aligning a pixilated micro-grid polarizer with an image sensor having similarly sized pixels is presented. This process is presented as an example of an alignment procedure carried out in accordance with the present invention, but it is not intended as the exclusive manner of performing such an alignment. For example, in one embodiment of the invention, output signals from the camera are provided to a video display unit for observation by a human operator. Based on the displayed video images, the operator may perform the positioning adjustments described below with the assistance of the positioning unit. In other embodiments, the entire alignment procedure may be automated and under the control of the controller. In still further embodiments, a hybrid approach that makes use of automated procedures with human oversight or intervention may be implemented.

At 502, the alignment procedure is initiated. Depending on the alignment system configuration, this generally involves activating (i.e., powering up) the imaging sensor and adjusting it to run with the suitable exposure and gain settings. The light source (collimated to impinge on the sensor plane along the surface normal to the sensor plane) is also activated and adjusted to provide uniform illumination over the imaging sensor area. The end result of adjusting light source intensity and camera settings must not saturate any pixel (meaning that the sensor output signal is maximized). Because the polarizer would reduce light strength, it is preferable to perform this lighting/camera adjustment at least twice, once initially, before polarizer is inserted into the system (for the purpose of providing feedback to adjust the uniformity of light), and at least one more time after the polarizer is inserted into the system. The goal is to prevent saturation of the maximum values of the sensor output while at the same time maximizing the use of the linear dynamic range of the sensor to distinguish differences in light signal strength sensed by different pixels.

At 504, coarse alignment of the imaging sensor (i.e., the camera) and the micro-grid polarizer takes place. This involves setting up the camera, with the imaging sensor, and the micro-grid polarizer in the alignment system, with one or both of these units in the stage or frame of the positioning system. The coarse alignment may be done visually, with the aid of a mirror or small extra camera. Note, in some implementations, the location or positioning of alignment jigs, mounting hardware for the light source and/or manipulator arms may make it impossible or very awkward to position an operator's eye along the correct observation position for the coarse alignment of the pixels of the micro-grid polarizer over corresponding pixels of the imaging sensor. To aid in the coarse alignment process, an intensity video signal output from the camera may be displayed on a monitor (e.g., a display of a computer system configured to provide an intensity reading output) and the position of the micro-grid polarizer adjusted relative to the camera/imaging sensor. At this stage, the distance between the polarizer and the imaging sensor is great for the grid structure of the polarizer to become visible to the imaging sensor output. The main visual cue for the coarse alignment is thus the polarizer edges.

Without a lens the imaging sensor is extremely short sighted. Therefore, when the polarizer is first inserted into the light path above the sensor, separated therefrom by a few inches, the only feedback is that the overall brightness of the displayed image becomes a little dimmer. As the polarizer is slowly lowered closer to the imaging sensor, blurry shadows of the edges of the polarizer become more and more well-defined. As the polarizer is usually not perfectly parallel to the sensor at this stage, one would observe that one of the corners of the polarizer would land first. Visually, the corner that reaches within few microns of the imaging sensor would have much sharper edge images than the other corners. If liquid glue is applied all across the imaging sensor before lowering the polarizer, the liquid layer can act as low quality lens that aids in producing sharper images of the edges during the last few microns approach of the polarizer and the surface tension of the liquid layer may aid in pulling in the polarizer towards the sensor, bringing all corners to more level position.

During these operations, it is important to keep monitor the visual feedback during the approach of polarizer and reduce the separation distance between the polarizer and the imaging sensor slowly and cautiously so that one corner of the polarizer is not crushed into the surface of the imaging sensor violently. Such a crash would likely damage the polarizer and/or the sensor and produce unwanted debris therebetween that can be hard to clean out later. After it is observed that the polarizer is roughly level and in relatively close proximity to the imaging sensor (e.g., close enough to enable visual observation of the corners and edges clearly) a rough alignment to bring the edges and corners to desired locations relative to the imaging sensor is performed.

Once the coarse alignment is finished, the separation distance between the sensor and the micro-grid polarizer is adjusted to make sure that they are in closest proximity to one another (506). In one embodiment, the polarizer mount is not completely rigid but has a slightly springy buffer layer between the polarizer and the more rigid part of the holder, so that when enough pressure is applied to press the polarizer holder against the imaging sensor, the final degree of parallelism is achieved automatically, provided that both the polarizer and the sensor chips are made to be sufficiently planar without warping.

At this stage a linear polarizer between the light source and the chip assembly is rotated close to parallel to one of the angles of the pixels of the micro-grid polarizer (e.g., 0°, 45°, 90° or)135°. The purpose of polarized light here is to introduce contrast between adjacent polarizer grids sufficient to be used as feedback signal. It need not be a maximum possible contrast. Within a few degrees of alignment of the best alignment, the contrast between adjacent polarizer grid cells varies little for the present purpose.

The signal intensity of the micro-grid polarizer pixels with the corresponding polarization angle is displayed (in the case where a monitor is used) or analyzed by the controller (in the case of the fully- or semi-automated system) for the four corners and the center of the image. The sizes of the monitored windows depend on the controller capability relative to the total number of pixels on the sensor. With enough computation speed and memory relative to the number of pixels on the sensor, all pixels can be placed under constant monitoring all the time.

The separation distance between the micro-grid polarizer and the imaging sensor is decreased (with the controller issuing appropriate commands to the positioning unit) by pressing the polarizer holder toward the image sensor a fraction of microns at a time and observing how much more “in-focus” the edges and grid patterns become. After a few increments, there is no further improvement and the z-position (i.e., the vertical displacement from the plane of the imaging sensor) of the manipulator is noted. The micro-grid polarizer is then backed off (i.e., displaced from the noted z-position) a few microns, without introducing blurring or decreasing contrast of the polarizer edges and corners and some rough aligned patterns. The idea here is to keep the polarizer close enough in the depth of field of the imaging sensor so that clear visual feedback is maintained, while at the same time sufficient separation between the micro-grid polarizer and the imaging sensor is introduced so that subsequent changes in position and attitude of the micro-grid polarizer do not scratch the polarizer against the imaging sensor.

Next, at 508, the light source is adjusted to provide polarized light approximately aligned with one of the polarization angles in the micro-grid polarizer. For example, the 0° angle. The video monitor (if one is used) is adjusted to display a pseudo-color for human viewing or for machine monitoring of the hue value of such pseudo-color. Misalignment due to rotation, tilt and chip warping, and grid-pitch mismatch are reflected in characteristic non-uniform hue patterns across the image output. With this feedback, changes in rotation and tilt axes are made so as to reduce the hue variation patterns.

Since mechanically there is always some residual coupling between axes this process is iterative in nature. An adjustment in one axis to reduce its particular hue variation may result in the increase of hue variations in different axes. With a perfectly matched imaging sensor and micro-grid polarizer pair, the unwanted hue pattern would eventually reduce to a acceptable level. For example, the local standard deviation of hue at the four corners and the center may be within a predetermined tolerance when the two are considered to be sufficiently aligned. This process is repeated several (e.g., two to four) times, each time with the rotatable polarizer 404 rotated to at least two 90 degree apart angles (because the micro-grid polarizer cells that is approximately 90 degrees to that of linear polarizer 404 shows very little signal so any defects or misalignments in that particular polarizer grid group can not be observed very well). Time permitting, the polarizer 404 can be changed to all four orientations before completion of this stage (510).

When the angular alignment is complete, the video monitor may be switched to display the original grey-level and local extinction ratio signal and/or the controller will begin monitoring this parameter from the camera output 512. The light source is adjusted to provide polarized light at selected polarization angle 514 and the extinction ratios R1 and R2 are displayed/analyzed for the four corners and the center of the image. The local contrast between adjacent lines and columns in the x and y directions (i.e., in the plane of the image sensor) gives guidance to whether the x or y direction is misaligned more. For example if the y-direction is misaligned more than the x-direction, the contrast between adjacent columns would be low or even close to nil, while the contrast between the adjacent rows could be much higher and more visible. The best alignment position is achieved when both the x and y direction between line contrast is highest and that the R1 and R2 values reach their relative maximum values. Note that there are no absolute maximum values, only relative maximum values between different alignment states for each micro-grid polarizer. The actual values are linked to many factors, and can vary across individual polarizers and setup conditions. Hence, the positioning system is manipulated, 516, either under the control of an operator or the controller, so as to adjust the relative position of the micro-grid polarizer and imaging sensor until this condition is achieved, 518.

Since mechanical manipulators always have certain cross-coupling between axes, it is often necessary to go back and forth between alignment steps until satisfied that improvement in one view did not cause degradation in another view. When this condition is satisfied, the polarizer is pressed as closely as possible against the imaging sensor to see if any improvement in the ratios R1 and R2 is provided. If any further fine adjustments need to be made, this pressure must be released before any relative manipulation of the position and/or attitude of the micro-grid polarizer or the imaging sensor. Once satisfied with the alignment (e.g., judging from feedback such as the hue uniformity, the local contrast values and the R1/R2 values), the units are deemed to be aligned and may be affixed in position, 520, for example using an optical epoxy glue or other means.

In various embodiments, controller 406 may be a computer system or other apparatus having a computer processor communicatively coupled with a memory or other storage device, storing information and instructions to be executed by the processor as well as temporary variables or other intermediate information during execution of instructions to implement the above-described procedures. In some instances, the computer-executable instructions which comprise an embodiment of the present methods may be stored on a read only memory (ROM) or other static storage device (e.g., a hard disk drive) communicatively coupled to the processor. Such an apparatus may also include a display device, such as a cathode ray tube (CRT), liquid crystal display (LCD) or other display means, for displaying information to a user. An input device, including alphanumeric and other keys, and/or a cursor control device, may be provided for communicating information and command selections to the processor.

According to one embodiment of the invention, aspects of the alignment operation discussed above are facilitated by a computer-based system executing sequences of instructions contained in a storage device. Such instructions may be read from one or more computer-readable media, such as a floppy disk, a flexible disk, hard disk, magnetic tape, or any other magnetic medium, a CD-ROM, a DVD-ROM, any other optical medium, punch cards, paper tape, any other physical medium with patterns of holes, a dynamic memory, a static memory, or any other medium from which a processor or similar unit can read instructions. Execution of the sequences of instructions contained in the storage device causes the processor or other operating unit to perform the process steps described above. In alternative embodiments, hard-wired circuitry may be used in place of or in combination with computer software instructions to implement the methods discussed herein. Thus, embodiments of the invention are not limited to any specific combination of hardware circuitry and software and, where used, software written in any computer language (e.g., C#, C/C++, Fortran, COBOL, PASCAL, assembly language, markup languages, object-oriented languages, and the like) may be used.

An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. Unless specifically stated otherwise, it should be appreciated that the use of terms such as “processing”, “computing”, “calculating”, “determining”, “displaying” or the like, were intended to refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Thus, systems and methods for aligning a pixilated micro-grid polarizer to an image sensor having multiple pixels have been described. The present active alignment process for a micro-grid polarizer and an image sensor having similarly sized pixels has advantages over passive alignment techniques since the camera live signal is monitored and used in making decisions regarding a best alignment and no expensive and complex microscope or coaxial lighting is needed. In particular, this technique can be easily applied for alignment of pre-packaged sensors with separately manufactured and cut polarizers. Alignment marks and microscopes have been used by semiconductor manufacturers at wafer level when pre-designed alignment marks can be made and accurate geometry can be maintained in clean room factory environment. However, when one only has access to packaged sensor chips there are no such alignment marks available and no ready-made jigs that can put the separately made polarizer chips in very close parallel position for alignment. Lighting must also be considered. For polarizer grids, there is no contrast between pixel cells under normal, unpolarized light illumination so it is very difficult to see the polarizer grid boundary for alignment. In order to produce good contrast between grids, it is best to provide polarized light and to put the polarizer between the light and the sensor to get the desired contrast (not all polarizers also polarize in the reflecting setup). The light needs to be able to have easy polarization orientation control while at the same time needs to be collimated to be incident on the alignment surface along the surface normal position, a complex and costly setup. Another advantage of the present invention is that the direct output of the live signal of the sensor represents the actual usage of the final product. The maximized local contrast and extinction ratios and peak average signal is directly linked to the best possible actual polarization camera performance, while alignment done with non-active alignment methods do not have direct linkage between the alignment quality indicator and the final product performance.

What is claimed is:

1. A method of aligning a pixilated micro-grid polarizer to an imaging sensor having multiple pixels, the method comprising:
performing a coarse optical alignment of respective corresponding pixels of the pixilated micro-grid polarizer with pixels of the imaging sensor;
adjusting a separation distance between the pixilated micro-grid polarizer and the imaging sensor to be a minimum; and
aligning the respective corresponding pixels of the pixilated micro-grid polarizer with the pixels of the imaging sensor in at least six degrees of freedom using an output of the imaging sensor.

2. The method of claim 1, wherein the coarse optical alignment is performed using a mirror or additional camera to position the micro-grid polarizer coarsely over the pixels of the imaging sensor.

3. The method of claim 1, wherein during the coarse optical alignment, an intensity video signal output from the imaging sensor is displayed on a monitor and the micro-grid polarizer is moved relative to the imaging sensor using visual feedback provided via the output of the imaging sensor, said feedback including blurry to in-focus transitions indicating desired separation distance is achieved.

4. The method of claim 1, wherein during the coarse optical alignment, an intensity video signal output from the imaging sensor is provided to a controller and the controller operates a positioning system to move the micro-grid polarizer relative to the imaging sensor.

5. The method of claim 1, wherein the minimum separation distance between the imaging sensor and the micro-grid polarizer is determined by illuminating the imaging sensor using light that is polarized parallel to one of a plurality of angles of pixels of the micro-grid polarizer and adjusting the separation distance between the imaging sensor and the micro-grid polarizer until a contrast of an output of the imaging sensor for those pixels of the imaging sensor aligned with pixels of the micro-grid polarizer of a corresponding polarization angle to the light is maximized.

6. The method of claim 1, wherein aligning the respective corresponding pixels of the pixilated micro-grid polarizer with the pixels of the imaging sensor comprises illuminating the imaging sensor with polarized light aligned with one of a plurality of polarization angles of pixels of the micro-grid polarizer, rotating the imaging sensor and micro-grid polarizer relative to one another about a common axis while monitoring a pseudo color display and minimizing hue variations across the imaging sensor.

7. The method of claim 1, wherein aligning the respective corresponding pixels of the pixilated micro-grid polarizer with the pixels of the imaging sensor comprises illuminating the imaging sensor with depolarized light; monitoring local inter-column and inter-row contrast and extinction ratios of an output of the imaging sensor; and translating the imaging sensor and the micro-grid polarizer relative to one another in a horizontal plane, while maintaining, as much as possible, a constant separation distance and rotational aspect therebetween, until the contrast and extinction ratio values reach their respective maximum achievable values.

8. The method of claim 1, further comprising affixing the micro-grid polarizer to the imaging sensor upon completion of the alignment process.
